(19) United States
(12) Patent Application Publication
(10) Pub. No.: US 2017/0238478 A1
(43) Pub. Date: Aug. 24, 2017

(54) GARDEN PLOT ENCASEMENT SYSTEM

(71) Applicant: Olivia Louise Brough, Powell, OH (US)

(72) Inventor: Olivia Louise Brough, Powell, OH (US)

(21) Appl. No.: 15/437,203

(22) Filed: Feb. 20, 2017

Related U.S. Application Data
(60) Provisional application No. 62/297,599, filed on Feb. 19, 2016.

(51) Int. Cl. A01G 13/02; A01G 9/14; A01G 13/10; A01G 9/16

(52) U.S. Cl. CPC A01G 13/0206; A01G 9/16; A01G 9/1407; A01G 13/105; A01G 13/10

(57) ABSTRACT

A device for encasing a plot of land is disclosed. The device includes a modular base placed around the perimeter of the plot of land. The base has a slot in the top for receiving a number of panels that form the sides and top of the enclosure. A bottom screen may extend across the bottom of the base. The panels may have an opening which is covered by an insert panel. The insert panel may be a screen or a material having greenhouse properties.

### CROSS-REFERENCE TO RELATED APPLICATION

This application claims the benefit of U.S. Provisional Patent Application Ser. No. 62/297,599 filed on Feb. 19, 2016, which is hereby incorporated by reference in its entirety.

### TECHNICAL FIELD

Exemplary embodiments of the present invention relate generally to a system and apparatus for encasing a plot of land.

### BACKGROUND AND SUMMARY OF THE INVENTION

Gardening is a hobby enjoyed by many. It is also the means by which many individuals cultivate fresh fruits, vegetables, herbs, flowers and other plants for consumption and use. These plants, however, are a popular target for animals and insects who eat or otherwise harm or destroy the plants. These plants are also sensitive to, and often harmed by, environmental conditions such as under- or over-exposure to sunlight, heat, cold, wind, moisture, frost, snow, and other environmental conditions. Many gardeners cultivate plants which are not native to the area where they are being gardened and thus are not naturally equipped to contend with local animals and insects as well as environmental conditions, which can cause the need for even more stringent protection. To combat these and other problems, gardeners have sometimes taken to placing netting, fencing, or other materials around their garden plots.

Fencing, however, is generally only able to prevent larger animals from entering and netting is ineffective or harmful to some animals. For example, birds may get caught up in the netting and larger animals may chew through the netting, push the netting in and eat the plants as they stick through the small openings, or simply trample the netting and damage the plants.

Additionally, placing fencing and netting generally requires that the gardener erect a series of stakes and connect netting or fencing there between. To provide environmental protection, some gardeners have taken to also placing sheets or tarps over their plants in inclement weather, such as during periods of low temperature, frost, snow, freezing rain, hail, or excessive rainfall. Other gardeners may place plastics shells over their garden plots or erect expensive and complex greenhouse shelters for similar reasons. These efforts can be involved, expensive, strenuous, and time consuming. These efforts also fail to completely encase the plants, as the netting does not protect from burrowing animals and insects such as moles, ants, mice, groundhogs, rabbits, shrews, woodchucks, cicada, and the like. Further, many such contraptions are unsightly and often prohibited by neighborhood association or other civic organizations.

Further still, these systems are generally one-size-fits-all and are not adaptable to various size and shaped plots. Neither are they modular, allowing for resizing or shaping of the plot of land or the encasement at a later point. They may also not permit screens to be interchanged with greenhouse-type or moisture impermeable panels and vice versa to accommodate changing seasons and weather conditions.

Therefore, what is needed is a system for completely encasing garden plots that provides for simple assembly, protection from animals, insects, environmental conditions, or all the above, is modular, is adaptable, and is aesthetically pleasing. The present invention provides a system and apparatus for completely encasing garden plots that is simple to assemble, is capable of protecting the plants located therein from animals, insects, and environmental conditions, is modular, is adaptable, and is aesthetically pleasing.

The present invention comprises enclosures of different sizes and shapes, which can also be configured for various purposes. The enclosure may include a base which forms a wall around a perimeter of the garden plot. The base may have a slot located in the top surface thereof and said slot may extend around the perimeter of the base. The base portion may further comprise a netting or fencing portion located on the bottom surface thereof.

The present invention may further comprise a series of enclosure components that are configured to be mated to the slot in the base. The enclosure components may include corner pieces, interchangeable insert panels, panels, connectors, supports, and roof pieces. The various enclosure components may be configured to mate with and be secured to one another. The enclosure pieces may be configured to be modular, meaning that enclosure pieces can be rearranged and interchanged to adapt to various size plots. Additionally, enclosure pieces can be added to or removed from an existing enclosure. Each of these enclosure pieces may comprise screens, cages, mesh, paneling, or the like. Appropriate enclosure pieces may be interchanged to adapt to varying environmental conditions.

In other exemplary embodiments, the base may comprise a cage portion located atop thereof and configured to be secured thereto. Likewise, the base portion may further comprise a netting or fencing portion located on the bottom surface thereof.

It is contemplated that the present invention may be of various shapes and sizes to accommodate various size garden plots and plants. It is also contemplated that the enclosure components or the cages may be comprised of various size and type netting or fencing, or be comprised of other insert materials to prevent exposure to environmental conditions.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a perspective view of an exemplary embodiment of the present invention as installed in an exemplary garden plot;

FIG. 2 is a detailed perspective view of an exemplary base;

FIG. 3 is a perspective view of various exemplary enclosure components;

FIG. 4 is a perspective view of an exemplary embodiment of the present invention in a partially assembled form and further illustrating detail A;

FIG. 5A is a perspective view of an exemplary roof piece;

FIG. 5B is a perspective view of an interchangeable insert panel;

FIG. 6 is a detailed perspective view of detail A of FIG. 4;

FIG. 7 is a perspective view of another exemplary embodiment of the present invention;

FIG. 8 is a perspective view of another exemplary embodiment of the present invention;

FIG. 9 is a top view of another exemplary embodiment of the present invention;

FIG. 10 is a perspective view of another exemplary embodiment of the present invention;

FIG. 11 is a front view of the device of FIG. 10;

FIG. 12 is a side view of the device of FIG. 10;

FIG. 13 is a top view of the device of FIG. 10;

FIG. 14 is a rear, underside perspective view of an exemplary panel for use with the present invention;

FIG. 15 is a rear view of the panel of FIG. 14;

FIG. 16A is a left side view of the panel of FIG. 14 also indicating detail B;

FIG. 16B is a detailed side view of detail B of FIG. 16A;

FIG. 17A is a right side view of the panel of FIG. 14 also indicating detail C;

FIG. 17B is a detailed side view of detail C of FIG. 17B;

FIG. 18 is a top view of the panel of FIG. 14;

FIG. 19 is a rear perspective view of another exemplary panel for use with the present invention;

FIG. 20 is a rear view of the panel of FIG. 19;

FIG. 21A is a side view of the panel of FIG. 19 also indicating detail D;

FIG. 21B is a detailed side view of detail D of FIG. 21A;

FIG. 22 is a top view of the panel of FIG. 19;

FIG. 23 is a rear perspective view of another exemplary panel for use with the present invention;

FIG. 24 is a rear view of the panel of FIG. 23;

FIG. 25A is a side view of the panel of FIG. 23 also indicating detail E;

FIG. 25B is a detailed side view of detail E of FIG. 25A;

FIGS. 26 is a top view of the panel of FIG. 23;

FIG. 27 is a front perspective view of an exemplary interchangeable insert panel;

FIG. 28 is a front view the interchangeable insert panel of FIG. 27;

FIG. 29 is a side view of the interchangeable insert panel of FIG. 27;

FIG. 30 is a top view of the interchangeable insert panel of FIG. 27;

FIG. 31 is a front perspective view of an exemplary bottom panel;

FIG. 32 is a front view of the bottom panel of FIG. 31;

FIG. 33 is a front perspective view of another exemplary base;

FIG. 34 is a front view of the base of FIG. 33;

FIG. 35 is a side view of the base of FIG. 33;

FIG. 36 is a front perspective view of another exemplary embodiment of the present invention;

FIG. 37 is a rear perspective view of the device of FIG. 36;

FIG. 38 is a front view of an exemplary rear panel for use with the device of FIG. 36;

FIG. 39 is a top perspective view of an exemplary base for use with the device of FIG. 36;

FIG. 40 is a rear perspective view of an exemplary side panel for use with the device of FIG. 36;

FIG. 41 is a rear perspective view of an exemplary side panel for use with the device of FIG. 36; and

FIG. 42 is a front perspective view of an exemplary access panel for use with the device of FIG. 36.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

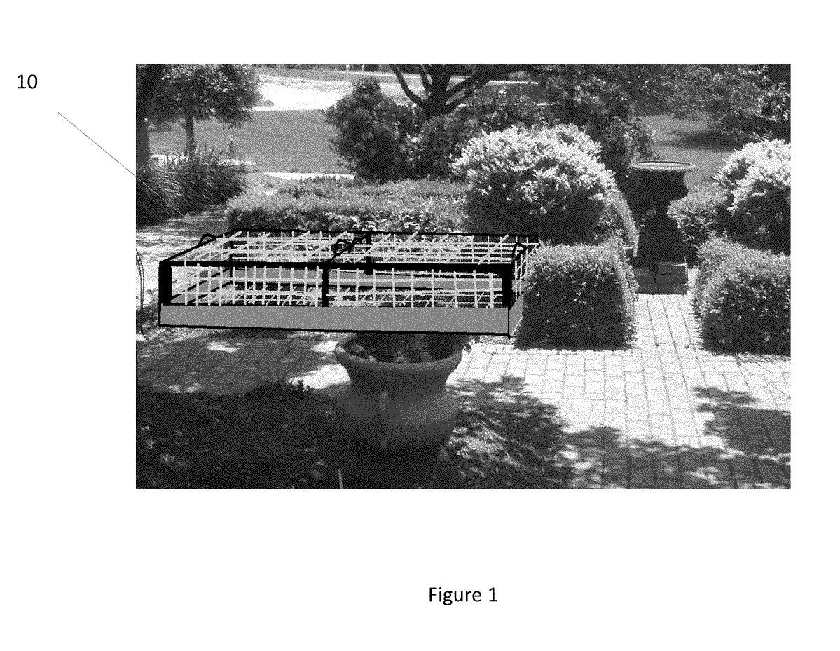

FIG. 1 illustrates an exemplary embodiment of the present device, indicated generally at 10, as located in an exemplary garden plot. It is contemplated that the present invention may be configured to fit any size and shape garden plot and any size and shape plants within said garden plot.

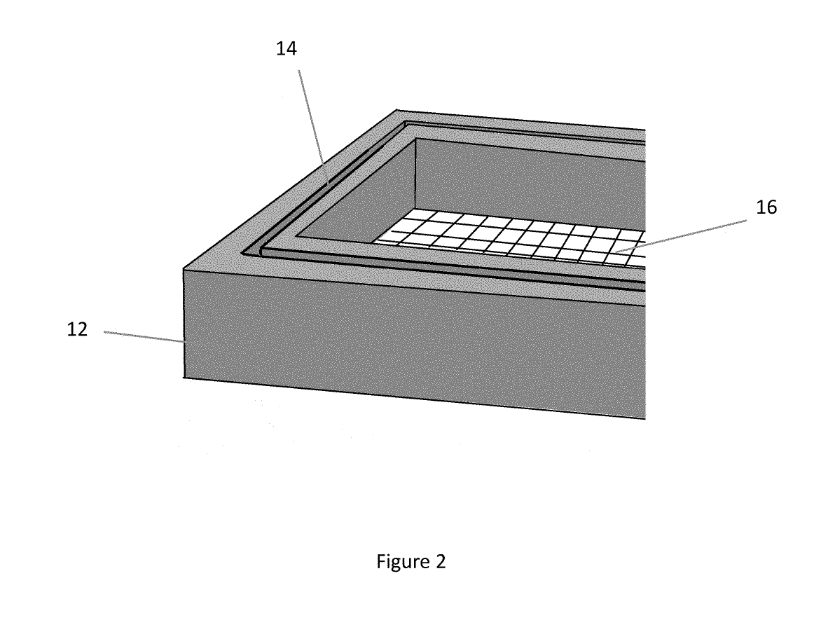

FIG. 2 illustrates a detailed view of a base 12 of the device 10. The base 12 may be a wall that extends the perimeter of the garden plot. As the garden plot may be of various sizes and shapes, the base 12 may likewise be of various sizes and shapes and may be so sized and shaped as to extend around the perimeter of said garden plot. The base 12 may be comprised of multiple modular segments that are assembled to form said base 12, or the base 12 may be integrally formed. The base may comprise a slot 14 located in the top surface thereof such that the slot 14 extends the perimeter of the base 12. As will be explained in greater detail in subsequent figures, the slot 14 may be configured to accept and secure various components. In exemplary embodiments of the present invention, the slot 14 may run the entire perimeter of the base 12. In other exemplary embodiments, the slot 14 may run only a portion of the perimeter of the base 12.

The base 12 may be comprised of wood, a polymer, a metallic material, some combination thereof, or the like. A bottom insert 16 may extend along and be attached to the bottom surface of the base 12. The bottom insert 16 may be netting, wire, weatherproof material, insulation, or the like. The bottom insert 16 may be buried below a layer of soil and may serve to protect the plants located therein from burrowing animals or insects. Likewise, a portion of the base 12 may also be partially buried below a layer of soil and further serve to protect the plants located therein from burrowing animals or insects.

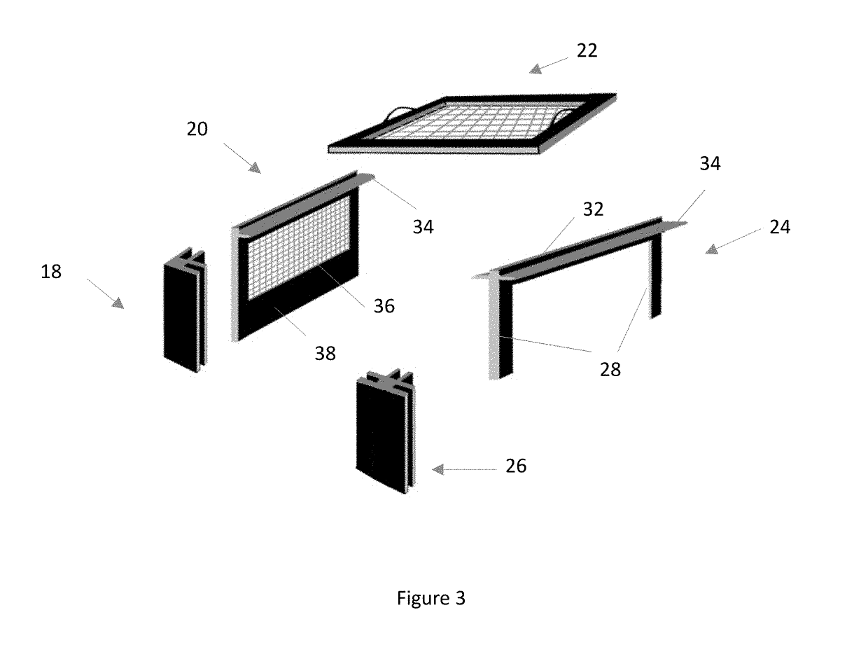

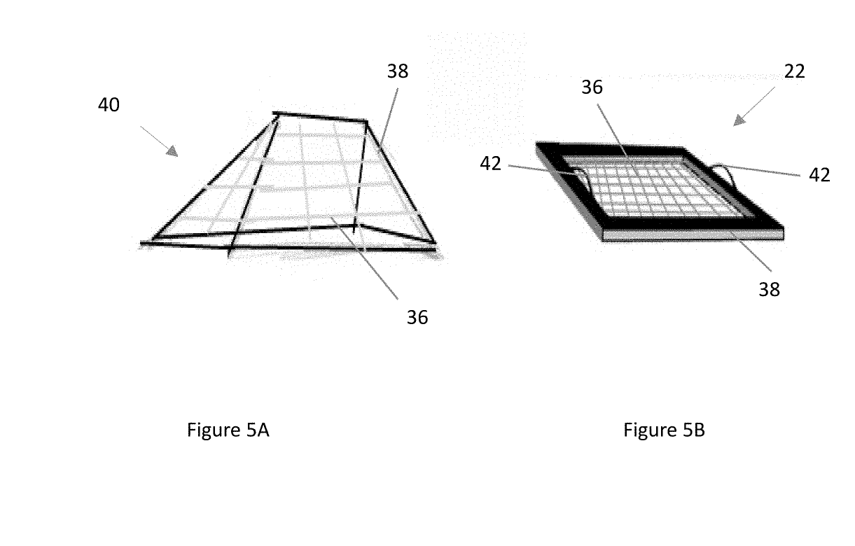

FIG. 3 illustrates various enclosure components. The enclosure components may include, but are not limited to, a corner piece 18, a connector 26, a support 24, a panel 20, an interchangeable insert panel 22, and roof pieces, which are explained in greater detail in FIGS. 5A and 5B. The interchangeable insert panel 22, in exemplary embodiments of the present invention, may serve as the roof pieces and/or as the panel 20. The enclosure components, with the exception of the roof pieces, may be configured to fit into the slot 14 of the base 12 or otherwise be assembled to form the upper enclosure structure of the present invention. The enclosure components shown are merely exemplary, other size, shape and type of components are contemplated.

The corner piece 18 may be formed at substantially a right angle and comprise a pair of slots extending the entire vertical length of the corner piece 18 or a portion thereof. The slots may be sized and configured to receive other components, such as the panel 20.

The connector 26 may be a rectangular shaped component comprising slots extending the entire vertical length of the connector 26 or a portion thereof. The slots may be configured to receive and thereby connect two adjacent panels 20 or other enclosure components. In other exemplary embodiments of the present invention, the connector 26 may be T-shaped, comprise three slots, and be configured to connect three of enclosure components including, but not limited to, the panels 20, the support 24, or other enclosure components. In still other exemplary embodiments, the connector 26 may be plus-shaped, comprise four slots, and be configured to connect four of enclosure components. It is contemplated that the connector 26 may be of any shape and comprise any number of slots to connect any number of enclosure components.

The panel 20 may be configured to be secured within the slot of the corner piece 18 and the connector 26. As will be explained in greater detail, the panel 20 may be comprised of a frame 38 and an insert 36. The frame 38 may form the perimeter of the panel 20 such that an aperture is located therein for placement of the insert 36. The frame 38 may be comprised of wood, a polymer, a metallic, some combination thereof, or the like.

The insert 36 may be located substantially within the aperture created by the frame 38 and be secured thereto. The insert 36 may be a netting or cage of any size apertures. The netting may be comprised of woven fabric, a polymer, or the like. The cage may be formed of wire, a polymer, a metallic material, or the like. In other exemplary embodiments of the present invention, the insert 36 may be a material, such as a polymer or the like, configured to control environmental conditions. For example, without limitation, the insert 36 may be comprised of a material configured to control moisture, wind, temperature, ambient light, or the like to control exposure to conditions such as, without limitation, wind, heat, cold, rain, dew, frost, sunlight, and other environmental conditions. As will be explained in greater detail in subsequent figures, in exemplary embodiments of the present invention, the panel 20 may not comprise the insert 36 and instead comprise an attachment mechanism 46 for the attachment of the interchangeable insert panel 22. In other exemplary embodiments, the panel 20 may not comprise the insert 36 and instead be a solid piece, such that there is no aperture in the panel 20.

The panel 20 may further comprise a shelf 34 located on an upper surface of the frame 38 such that it is located above the insert 36 and be secured to the frame 38 such that the shelf 34 is projected outwardly therefrom at a perpendicular angle to the surface of the frame 38. The shelf 34 may be configured to receive and support a roof piece.

The support 24 may be comprised of a pair of posts 28 connected at the upper end of said posts 28 by a beam 32. One or more shelves 34 may be secured to said beam 32 and extend perpendicularly therefrom. In exemplary embodiments of the present invention, a pair of shelves 34 may extend from each side of the beam 32. The shelves 34 may be configured to receive and support the one or more roof pieces. The posts 28 may be configured to be received and secured within the slots of the corner piece 18 and the connector 26. In this way, the support 24 may provide structural rigidity without projecting into and dividing up the internal space. The support 24 may additionally be used to connect multiple sections of the device 10. For example, but not to serve as a limitation, one of the panels 20 may be replaced with the support 24 in order to extend the size of the device 10. The support 24 may additional serve to partition sections of the device 10.

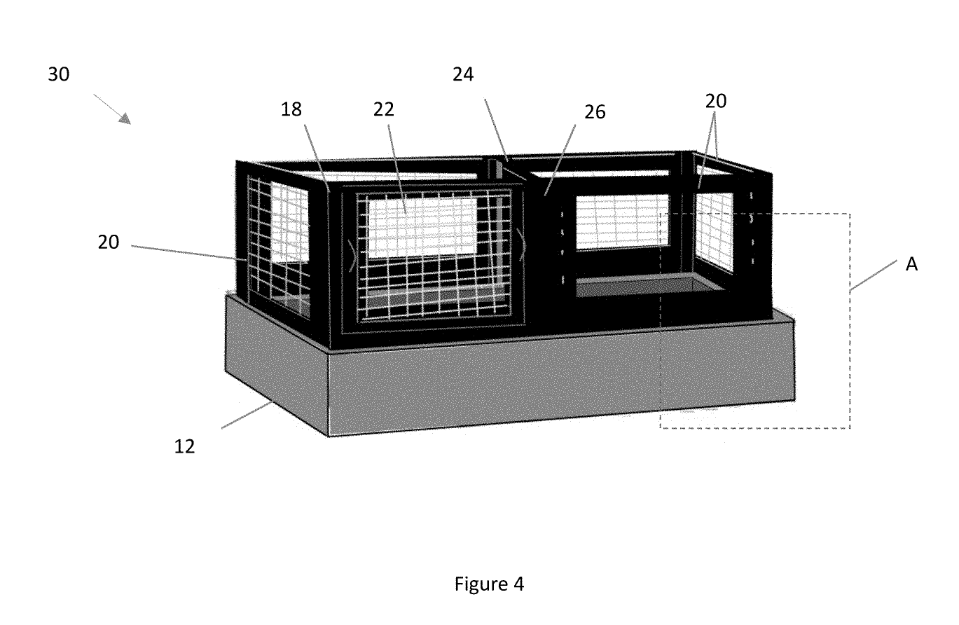

FIG. 4 illustrates an exemplary partial assembly 30 of the enclosure components. The assembly 30 is merely one possible example and is not intended to be limiting. The enclosure components may be arranged and interchanged in various combinations to fit the user's needs as well as to fit various size and shape garden plots and plants. In the present assembly 30, the base 12 is rectangular shaped. Four corner pieces 18 may be placed at each corner of the assembly 30. The corner pieces 18 may connect the panels 20. As will be explained in greater detail in subsequent figures, one or more of the panels 20 may not comprise an insert 36 and may instead comprise the attachment mechanism 46 for attaching the interchangeable insert panel 22. Two connector pieces 26 may connect interchangeable insert panels 22, panels 20, and one support 24. The support 24 may extend from one side of the base 12 to the other at substantially the midline of the base 12 and provide cross support. A full assembly of the present invention may require the use of roof pieces, such as those discussed in FIGS. 5A and 5B.

FIG. 5A and FIG. 5B illustrate exemplary roof pieces including a tent 40 and the interchangeable insert panel 22, respectively. The interchangeable insert panel 22 may have at least one handle 42 located thereon which facilitates easy removal and replacement of the interchangeable insert panel 22. Any kind of handle 42 is contemplated.

The tent 40 may be comprised of a frame 38. The frame 38 may comprise multiple members forming a tent-like structure such that the roof forms a peak. In exemplary embodiments, this structure may be formed by four members creating a rectangular shaped base, and two pairs of members extending upwards from said base and inwardly towards one another such that each pair forms a triangular shape. A member may extend between the two triangular-shapes such that a tent-like structure is formed. This configuration is merely exemplary, other shapes, sizes, and configurations of the members are contemplated to form various size and shape roof pieces. The tent 40 may further comprise an insert 36, which may be a netting or a material to control environmental conditions.

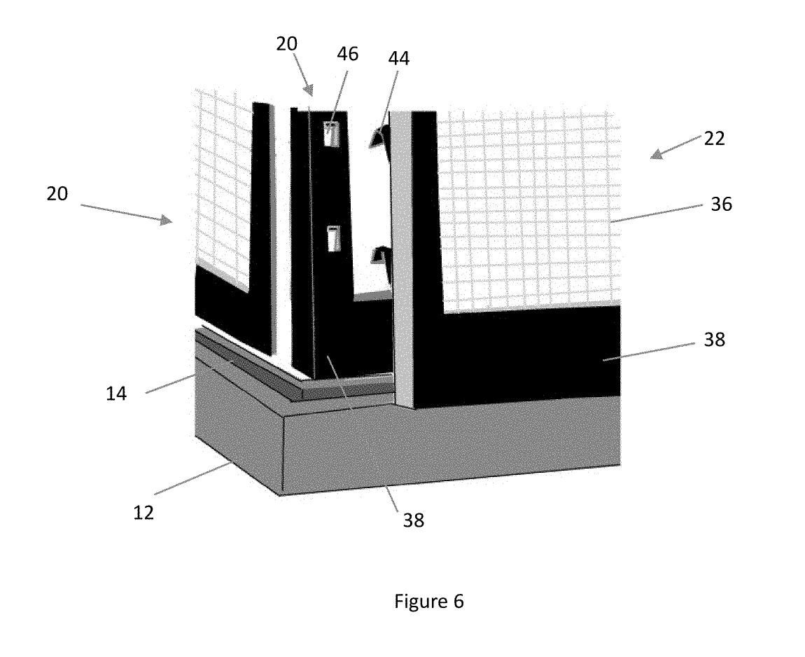

FIG. 6 illustrates a detailed view of detail A indicated in FIG. 4, which illustrates the attachment mechanism 46 in greater detail. The attachment mechanism 46 may include a notch or other receptacle on the frame 38 of the panel 20 or other enclosure component. A number of corresponding tabs 44 may be located on an outer panel, such as but not limited to the interchangeable insert panel 22 or other enclosure component, and be configured to mate with the notches or other receptacles such that that the interchangeable insert panel 22 may be selectively secured to the panel 20. This embodiment of the attachment mechanism 46 is merely exemplary, and any other attachment mechanisms 46 are contemplated including, but not limited to, magnets, hinges, slot and groove joints, hooks, sliding mechanisms, snaps, buttons, tie downs, and the like. The attachment mechanism 46 may additionally facilitate the easy removal of the outer panel and thus serve as an access point to the plants located therein. It is contemplated that the attachment mechanism 46, including the corresponding tab 44, may be used with any of the exemplary enclosure components.

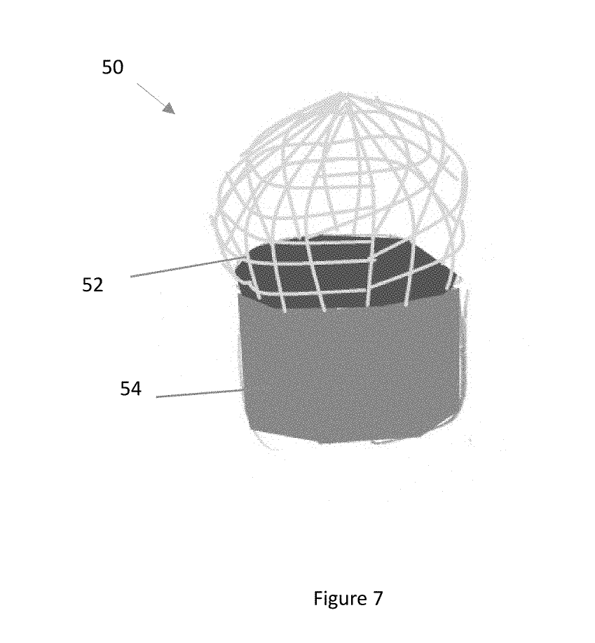

FIG. 7 illustrates another exemplary embodiment of an assembly 50 in accordance with the present invention. The assembly 50 may comprise a base 54 having a cage 52 located atop of and attached to said base 54. The base 54 may likewise comprise a slot in the top surface of the base 54 that is configured to receive the cage 52. The cage 52 may be a rigid structure and may be comprised of a metallic material. In this way, animals may not be able to press in on the cage 52 to reach the plants located therein.

In exemplary embodiments of the present invention, netting may be affixed to the cage 52 in order to keep insects and other critters out. In still other exemplary embodiments, other materials may be adhered to the cage 52 where such materials are configured to control environmental conditions. Additionally, a base insert may extend along and be attached to the bottom surface of the base 54 such that it prevents the intrusion of burrowing animals and insects.

It is contemplated that the base 54 and the cage 52 may be shaped and sized to fit any size garden plot and plant. In exemplary embodiments of the present invention, the assembly 50 is sized and shaped to protect an individual plant or grouping of plants, though such is not required.

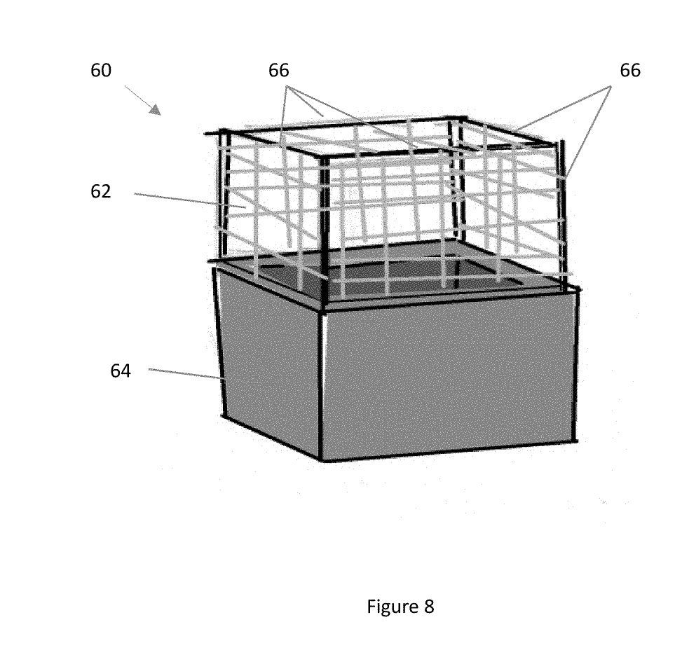

FIG. 8 illustrates another exemplary embodiment of an assembly 60 in accordance with the present invention. The assembly 60 comprises a base 64 having a cage located atop of and attached to said base 64. The base 64 may likewise comprise a slot in the top surface of the base 64 that is configured to receive the cage. The cage may comprise a series of beams 66 and a series of inserts 62. The beams 66 may be configured to be received in the slot. In other exemplary embodiments, the beams 66 may be otherwise affixed to the base 64. In exemplary embodiments, the beams 66 form a square shape which sits atop the base 64, though any other shape is contemplated.

The inserts 62 may be affixed to and extend between the beams 66. The inserts 62 may be a rigid and be comprised of a metallic material. In this way, animals may not be able to press in on the cage to reach the plants located therein. In exemplary embodiments of the present invention, the inserts 62 may be netting or netting may be affixed atop the insert. In still other exemplary embodiments, the inserts 62 may comprise other materials that are configured to control environmental conditions. Additionally, a base insert may extend along and be attached to the bottom surface of the base 64 such that it prevents the intrusion of burrowing animals and insects.

It is contemplated that the base 64 and the cage may be shaped and sized to fit any size garden plot and plant. In exemplary embodiments of the present invention, the assembly 60 is sized and shaped to protect an individual plant of grouping of plants, though such is not required.

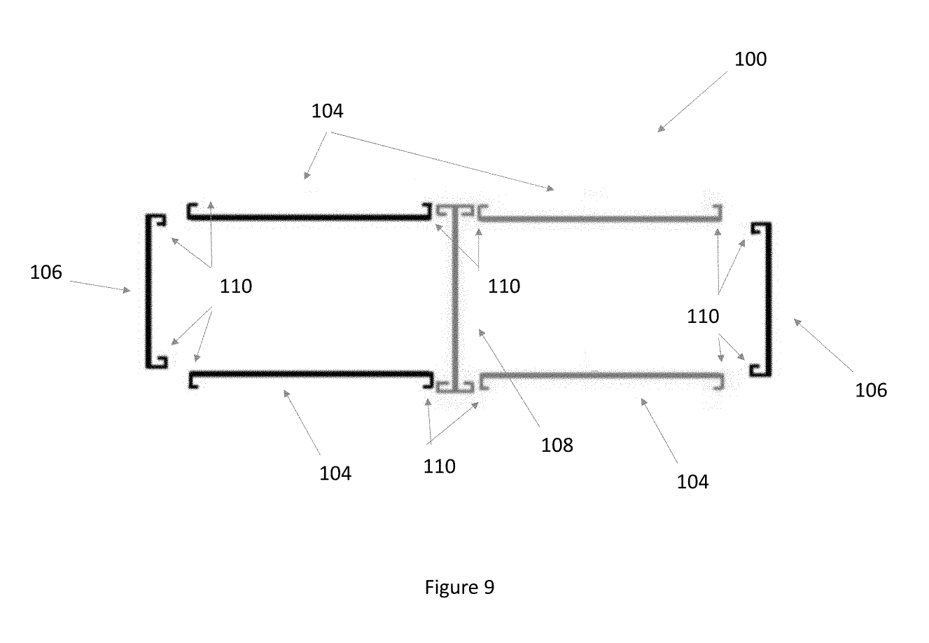

FIG. 9 is a top view of another exemplary embodiment of the device 100. The device 100 may comprise a number of components, such as but not limited to, front and rear panels 104, side panels 106, and supports 108. In exemplary embodiments of the present invention, the components may comprise a number of selectively attachable latches 110. The latches 110 may be connected to, or be integrally formed with, the components and may be curled, “C” shaped male and female pieces configured to mate. In exemplary embodiments of the present invention, the front and rear panels may comprise male latches 110 while the support 108 and the side panels 106 may comprise female latches 110, though it is contemplated that any component may comprise male or female latches 110.

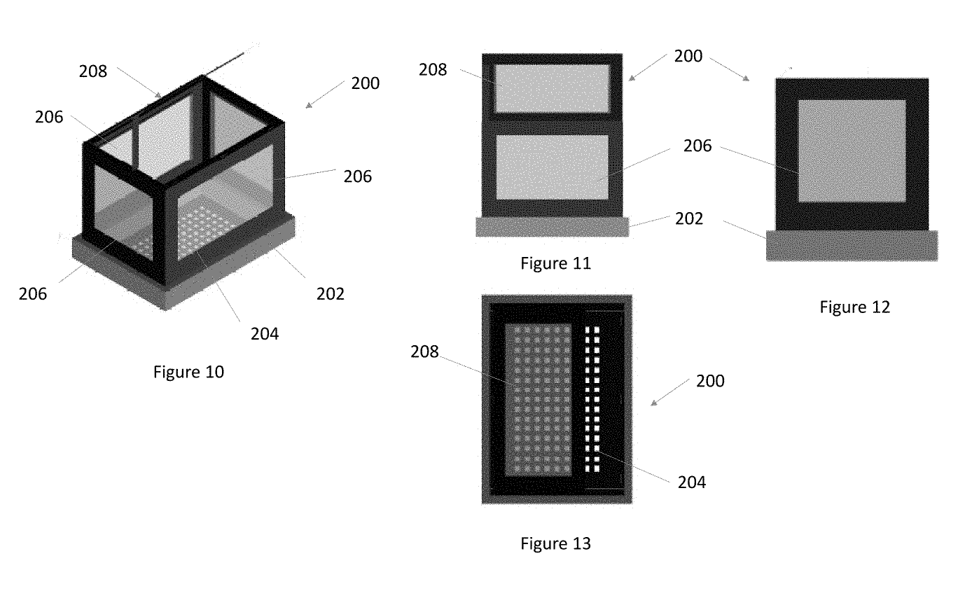

FIG. 10 through FIG. 13 illustrate another exemplary embodiment of the device 200. The device 200 may comprise a base 202, which may have a bottom panel 204 located along the bottom surface of the base 202 and may be comprised of a rigid material having a number of apertures therein. A series of side panels 206 may be configured to be secured within a slot located in the top of the base 202. A roof 208 may be hingedly attached to one or more of the side panels 206. The roof 208 may be attached such that it may be moved between a closed position whereby it rests on the top of the side panels 206 and to be manually swung upwards into an opened position such that it allows access to the interior of the device 200. In exemplary embodiments of the present invention, the base 202 is rectangular in shape such that when the side panels 206 and the roof 208 are assembled they form a rectangular shaped enclosure.

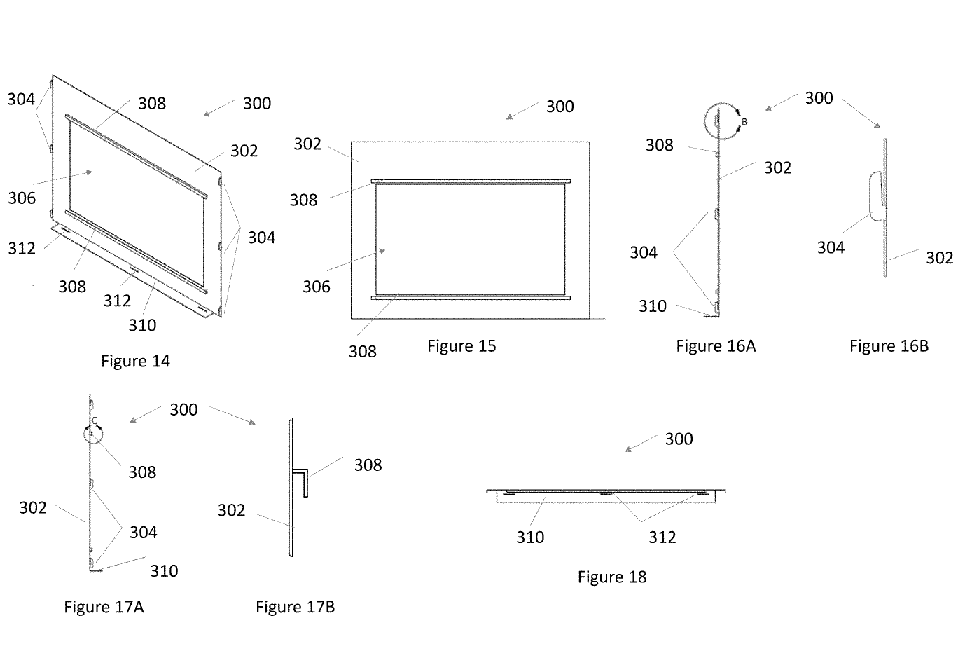

FIG. 14 through FIG. 18 illustrate an exemplary panel 300 for use with the present invention. It is contemplated that the panel 300 may be used with any of the embodiments described herein. The panel 300 may comprise a frame 302 that defines an aperture 306. In exemplary embodiments of the present invention, the aperture 306 is rectangular in shape, though any shape is contemplated. A guide rail 308 may be located above and below the aperture 306. The guide rails 308 may be configured to receive an insert panel, such as but not limited to, interchangeable insert panels 22 or 600 that may cover the aperture 306.

The panel 300 may further comprise a number of hooks 304 located on either side of said frame 302. In exemplary embodiments of the present invention, three hooks 304 are spaced apart and located on either side of the frame 302, however any number or location of hooks 304 are contemplated. The hooks 304 may be sized and configured to be attached to corresponding slots or apertures on other panels 300, 400, 500, 600, 700, or 800 or to other components of the device 10 or 200. In exemplary embodiments of the present invention, the hooks 304 are L-shaped and oriented to face downward, though any shape or orientation is contemplated.

The panel 300 may further comprise a ledge 310 that extends from the lower or upper edge of the panel 300. It is notable that FIG. 14 is a rear, underside perspective view such that the ledge 310 extends from a top portion of the panel 300 so as to support a roof panel. The ledge 310 may comprise a number of slots 312 therein. The slots 312 may be sized and located to accommodate corresponding attachment tabs on other panels 300, 400, 500, 600, 700, or 800 or in a frame for the device 10 or 200, or the attachment tabs 504. In exemplary embodiments of the present invention, the ledge 310 may be configured to support and be attached to one or more horizontally oriented panels that form the roof of the enclosure.

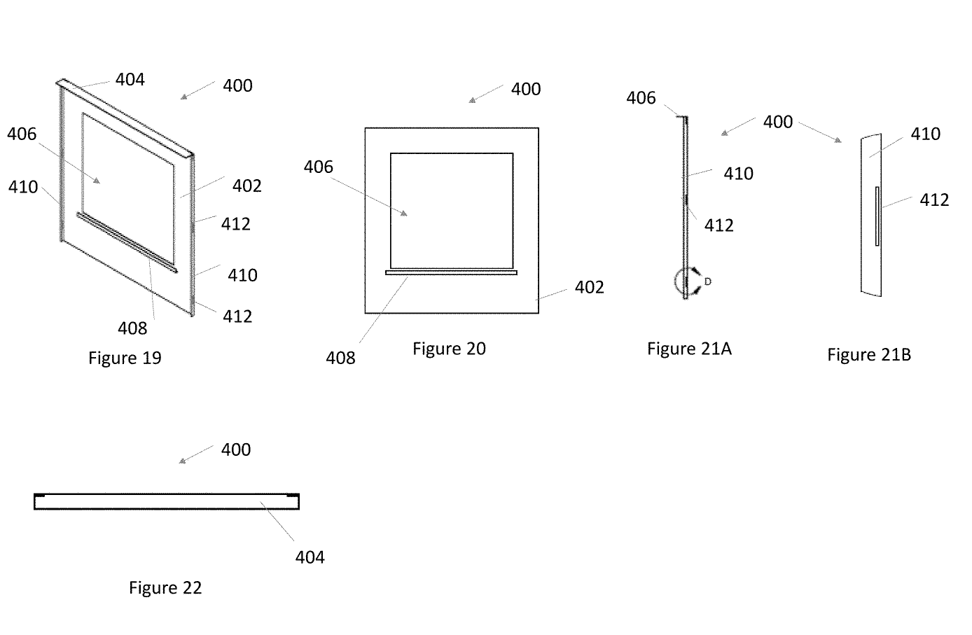

FIG. 19 through FIG. 22 illustrate another exemplary panel 400 for use with the present invention. It is contemplated that the panel 400 may be used with any of the embodiments described herein. Similar to panel 300, the panel 400 may comprise a frame 402 that defines an aperture 406. In exemplary embodiments of the present invention, the aperture 406 is rectangular in shape, though any shape is contemplated. A guide rail 408 may be located below the aperture 406, though it is contemplated that a second guide rail 408 may also be located above the aperture 406. The guide rail(s) 408 may be configured to receive an insert panel, such as but not limited to, interchangeable insert panels 22 or 600 that may cover the aperture 406.

The panel 400 may further comprise a pair of side panels 410 located on either side of the panel 402. The side panels 410 may comprise a number of slots 412 located therein. The slots 412 may be sized and located to accommodate corresponding attachment tabs on other panels 300, 400, 500, 600, 700, or 800 or another component of the device 10 or 200, or the attachment tabs 504.

The panel 400 may further comprise a ledge 404 that extends from the lower or upper edge of the panel 400. The ledge 404 may be configured to serve as a connection for other panels 300, 400, 500, 600, 700, or 800 or another component of the device 10 or 200. In exemplary embodiments of the present invention, the ledge 404 may be configured to support and be attached to one or more horizontally oriented panels that form the roof of the enclosure.

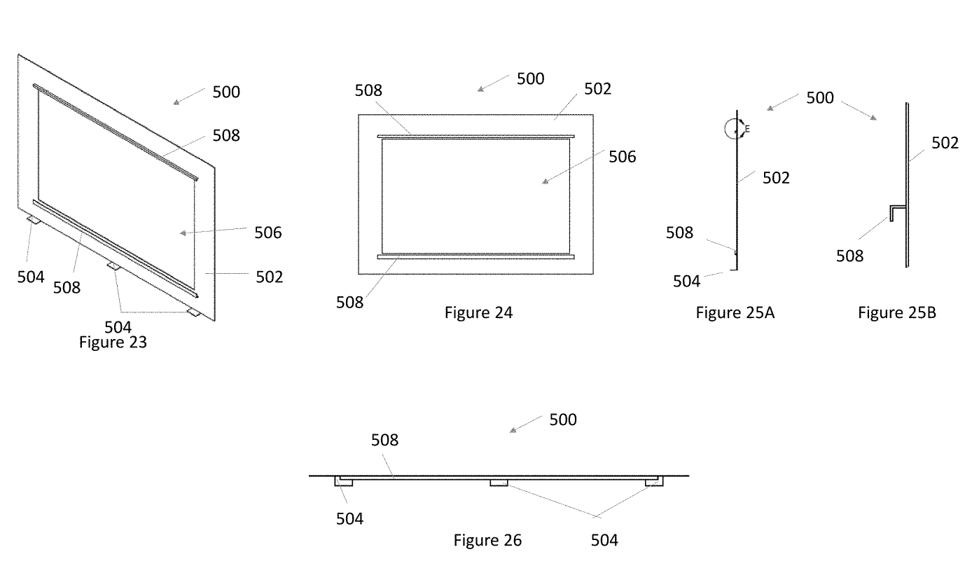

FIG. 23 through FIG. 26 illustrate another exemplary panel 500 for use with the present invention. It is contemplated that the panel 500 may be used with any of the embodiments described herein. The panel 500 may comprise a frame 502 that defines an aperture 506. In exemplary embodiments of the present invention, the aperture 506 is rectangular in shape, though any shape is contemplated. A guide rail 508 may be located above and below the aperture 506. The guide rails 508 may be configured to receive an interchangeable insert panel, such as but not limited to, interchangeable insert panels 22 or 600 that may cover the aperture 506. In exemplary embodiments of the present invention, the guide rails 508 may be “L” shaped, though any shape is contemplated.

The panel 500 may further comprise a number of attachment tabs 502 located on a lower or upper edge of the panel 500. In exemplary embodiments of the present invention, three attachment tabs 502 are spaced apart along the lower edge of the panel 500, though any location is contemplated. The attachment tabs 502 may be sized and located to be secured within slots 312 or 412 on other panels 300, 400, 500, 600, 700, or 800 or attach to other components of the device 10 or 200.

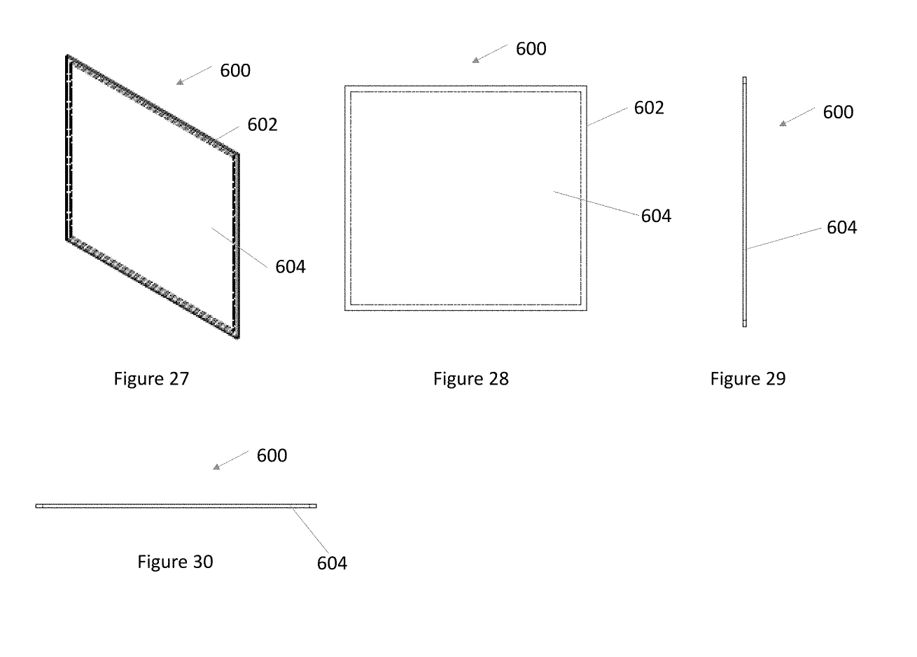

FIG. 27 through FIG. 30 illustrate another exemplary interchangeable insert panel 600 for use with the present invention. It is contemplated that the interchangeable insert panel 600 may be used with any of the embodiments described herein. The interchangeable insert panel 600 may comprise a frame 602 that extends the perimeter of the interchangeable insert panel 600. An insert 604 may be attached to the frame 602 and extend over the aperture created by the frame 602. In exemplary embodiments of the present invention, the insert 604 may be a screen or mesh with various size openings for use with various size apertures created by the frame 602. The screen or mesh may be configured to allow the interior of the enclosure to be exposed to environmental conditions, such as but not limited to, wind, plants, seeds, moisture, and the like, while preventing other element, such as but not limited to, animals and certain insects, from entering the enclosure.

In other exemplary embodiments of the present invention, the insert 604 may be a solid transparent, translucent, or opaque material having greenhouse properties. In such embodiments, the insert 604 may be configured to prevent both environmental conditions and other elements from entering the enclosure, such as but not limited to, moisture, wind, precipitation, animals, insects, or the like. The insert 604 may be configured, however, to allow sunlight to enter and may also reduce or prevent heat from escaping.

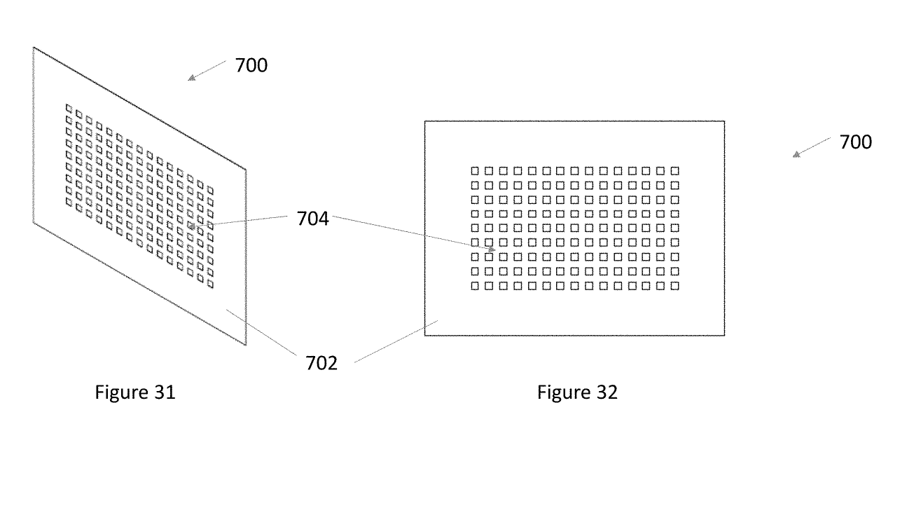

FIG. 31 and FIG. 32 illustrate an exemplary bottom panel 700 for use with the present invention. It is contemplated that the bottom panel 700 may be used with any of the embodiments described herein. The bottom panel 700 may be a solid panel 702 having a number of apertures 704 located therein. In exemplary embodiments of the present invention, the panel 702 may be comprised of a polymer or metal having a pattern of apertures 704 located therein. However, any material for the panel 702 is contemplated and any number of apertures 704 at any number of locations or in any pattern (or no pattern) is contemplated. Alternately, the panel 702 may be a screen, a network of metal wires arranged in a mesh, or the like.

The bottom panel 700 may be configured to fit within or be otherwise attached to the bottom of the device 10 or 200 such that the bottom panel 700 covers the aperture created in the bottom of the device 10 or 200 by the base 12, 202, or 800. The bottom panel 700 may be configured to allow dirt, nutrients, moisture, worms, and certain insects to pass into the enclosure while preventing other insects, animals, and the like from passing therethrough. In exemplary embodiments of the present invention, the bottom panel 700 is configured to be placed a few inches to several feet below the surface of the dirt in the enclosure.

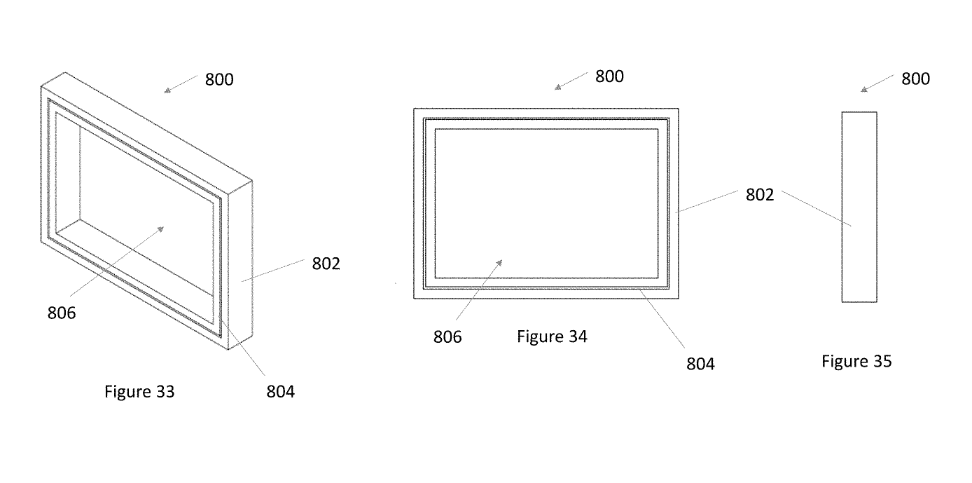

FIG. 33 through FIG. 35 illustrate an exemplary base 800 for use with the present invention. It is contemplated that the base 800 may be used with any of the embodiments described herein. The base 800 may comprise a frame 802 that extends the perimeter of the base 800. The base 800 may comprise a slot 804 that extends along the upper edge of the base 800. The slot 804 may be configured to receive one or more of the panels 300, 400, 500, 600, 700, or 800 or any other the other components described herein.

In exemplary embodiments of the present invention, the base 800 is rectangular shaped, though any shape is contemplated. The base 800 may further be comprised of a number of modular panels such that the base 800 can be formed and reformed into various shapes and sizes. Part of the frame 802 may be located below the surface of the dirt in the enclosure.

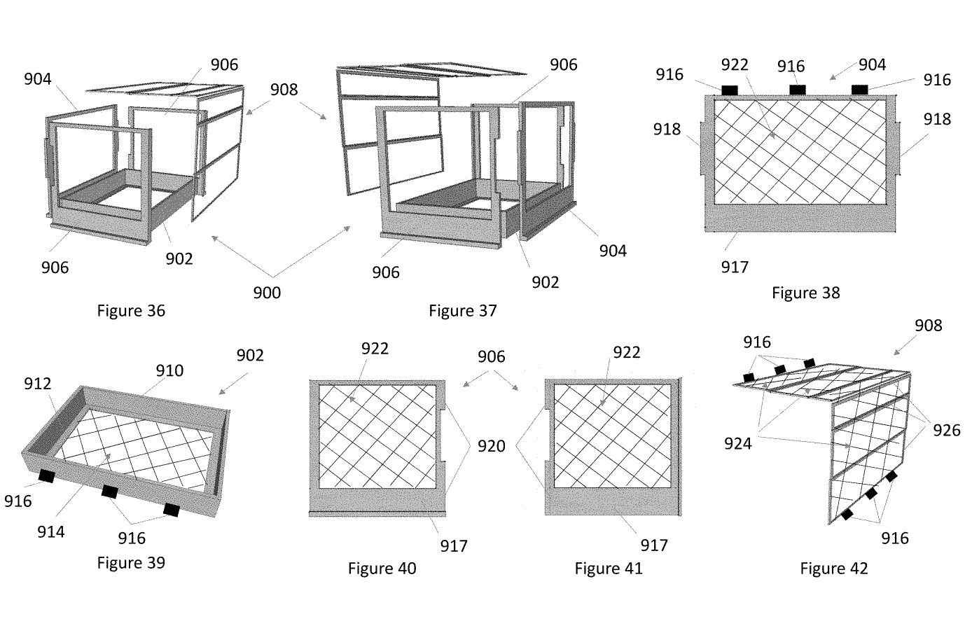

FIG. 36 through FIG. 42 illustrate another exemplary embodiment of the device 900. The device 900 may comprise a base 902, a pair of side panels 906, a rear panel 904, and an access panel 908 that are assembled together to fully encase a plot of land. The device 900 may be assembled in a rectangular shape, though any shape is contemplated. The device 900 may be modular such that additional or different shaped side panels 906, rear panels 904, access panels 908 may be added such that any size or shape plot of land may be encased.

The base 902 may comprise a number of modular pieces that form a perimeter wall 910 when assembled. A bottom insert 914 may extend across the bottom surface of the base 902 and may be comprised of a mesh, screen and configured to prevent burrowing animals from accessing the interior of the device 900. In other exemplary embodiments, the bottom insert 914 may be a solid material having a number of holes located therein and configured to prevent burrowing animals from accessing the interior of the device 900. For example, but not to serve as a limitation, the bottom insert 914 may be formed from a solid plastic sheet and have a number of cut or stamped out holes therein. Regardless, a ledge 912 may extend from the perimeter wall 910 for receiving the bottom insert 914, though the ledge 912 is not required. The base 902 may have a number of attachment members 916 located along the front wall of the base 902, the purpose of which will be explained in greater detail herein.

In exemplary embodiments, the base 902 may have a slot in the top surface thereof that extends the perimeter of the base 902. The side panels 906 and the rear panel 904 may be configured to be secured within the slot in the top surface of the base 902. In other exemplary embodiments, the side panels 906 may be secured to the rear panel 904 and the base 902 may be configured to fit snugly between the side panels 906 and the rear panel 904. In still other exemplary embodiments, the side panels 906 and the rear panel 904 may be attached or bonded to the base 902. The side panels 906 and the rear panel 904 may comprise a frame 917 defining an aperture which is covered by an insert 922. The insert 922 may be a screen or mesh configured to prevent animals and/or certain insects from access the interior of the device 900. In exemplary embodiments, the insert 922 may be comprised of a metallic wire.

The side panels 906 may comprise one or more attachment devices 920. The attachment devices 920 may be configured to interact with, and be secured to, corresponding attachment device 918 on the rear panel 904. In exemplary embodiments, the attachment devices 920 on the side panels 906 may comprise a pair of rectangular or cylindrical shaped members that extend from one edge of the side panel 906. The attachment device 920 may be spaced apart and positioned substantially in line along the edge of the side panel 906 and may have an aperture extending therethrough. The attachment devices 918 on the rear panel 904 may comprise a pair of attachment devices 918 that may extend from either side of the rear panel 904, and likewise comprise an aperture extending therethrough. The attachment devices 918 and aperture may be located such that when the device 900 is assembled the attachment devices 918 and 920, and the apertures therein, are substantially aligned. In this way, a member may be extended through all three apertures to secure the side panels 906 to the rear panel 904. The described attachment devices 920 and 918 are merely exemplary, any other attachment device(s) or method(s) for securing the side panels 906 to the rear panel 904 is contemplated.

The access panel 908 may comprise of a series of foldable or otherwise moveable sections configured to cover substantially the entire top and front surfaces of the device 900. Each section of the access panel 908 may comprise a frame 926 defining an aperture covered by a series of insert panels or a single mesh or screen 924. The access panel 908 may comprise a number of attachment members 916 configured to be secured to the attachment members 916 on the base 902 and the rear panel 904. In exemplary embodiments, the attachment members 916 may comprise hooks and loops, wherein the hooks are configured to be selectively secured to the loops. In this way, the access panel 908 may be selectively removed from the device 900 to allow access to the interior of the device 900. However, this is merely exemplary, any type of attachment member 916 for selectively securing the access panel 908 to the rear panel 904 and the base 902 is contemplated.

The device 900, including various portions of the side panels 906, rear panel 904, and/or the access panel 908 may be covered by a solid transparent, translucent, or opaque material having greenhouse properties. The material may be used in addition to, or alternatively to, the inserts 922 and/or the insert panels 924. The material may be configured to prevent both environmental conditions and other elements from entering the enclosure, such as but not limited to, moisture, wind, precipitation, animals, insects, or the like. The material may be configured, however, to allow sunlight to enter and may also reduce or prevent heat from escaping.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

1. A system for encasing a plot of land comprising:
a base configured to extend around the perimeter of said plot of land and defining a bottom opening;
a bottom panel configured to extend across the bottom opening and comprising a number of openings;
a slot in the upper surface of said base that extends the perimeter of said base;
a number of connector pieces configured to be secured within said slot, and comprising one or more vertically extending slots;
a number of panels configured to be secured within said slot in said base and said vertically extending slot in said connector pieces, said panels comprising:
a frame defining a panel opening, and
an insert configured to cover said panel opening; and
at least one interchangeable insert panel comprising:
a first frame defining an insert opening, wherein said first frame is configured to be secured within said slot in said base and said vertically extending slots in said connector pieces,
an attachment mechanism,
a second frame defining a second insert opening and configured to be selectively secured to said first frame via said attachment mechanism, and
an interchangeable insert configured to cover said insert opening and said second insert opening when said second frame is secured to said first frame;
wherein said plot of land is fully encased by said base, said connector pieces, said panels, said interchangeable insert panels, and said bottom panel.

2. The system of claim 1, wherein:
said interchangeable insert is a mesh; and
said insert is a mesh.

3. The system of claim 1, wherein:
said interchangeable insert comprises a material having greenhouse properties; and
said insert comprises a material having greenhouse properties.

4. The system of claim 1, wherein:
said interchangeable insert comprises a transparent or translucent and moisture impermeable material; and
said insert comprises a transparent or translucent and moisture impermeable material.

5. The system of claim 1, wherein:
said base is comprised of a number of modular segments.

6. The system of claim 1, wherein:
said attachment mechanism comprises:
a hook located on the second frame of said interchangeable insert panel, and
a corresponding aperture located on said first frame of said interchangeable insert panel configured to receive said hook.

7. The system of claim 1, further comprising:
one or more shelves extending perpendicularly from an upper portion of said panels and said interchangeable insert panels;
wherein said shelves are configured to receive said panel or said interchangeable panel in a horizontal position such that said received panel or said interchangeable panels form at least a portion of said roof of said enclosure.

8. The system of claim 1, further comprising:
a support member configured to be secured within said vertically extending slots in said connector pieces and extend perpendicularly to said panels or said interchangeable insert panels such that said support members extends across said plot of land to be encased.

9. The system of claim 8, further comprising:
one or more support shelves extending perpendicularly from an upper portion of said support member;
wherein said support shelves are configured to receive said panel or said interchangeable panel in a horizontal position such that said received panel or said interchangeable panels form at least a portion of said roof of said enclosure.

10. The system of claim 1, further comprising:
a roof piece comprising a number of members and a mesh extending between said members such that said roof piece forms a tent shaped structure.

11. A device for encasing a plot of land comprising:
a base configured to form a perimeter around said plot of land, wherein said base defines a bottom opening;
a bottom panel configured to extend over said bottom opening, wherein said bottom panel comprises a solid panel having a number of openings located therein;
a slot located in an upper surface of said base and extending along a perimeter of said base;
a number of panels, each defining an insert opening and each comprising at least one guide rail, wherein each of said panels are configured to be secured within said slot and to one another such that the base, the bottom panel, and the panels fully enclose said plot of land; and
a number of insert panels, each configured to be secured to one of said panels by way of said guide rails, such that said insert panels cover said insert opening when secured to said panels.

12. The device of claim 11, wherein:
said guide rails are L-shaped.

13. The device of claim 11, wherein:
a first portion of said panels comprises a plurality of hooks or tabs; and
a second portion of said panels comprises a plurality of slots;
said plurality of hooks or tabs are configured to mate with said plurality of slots.

14. The device of claim 11, wherein:
said number of insert panels comprises:
a frame defining an opening, and
an insert configured to cover said opening.

15. The device of claim 14, wherein:
said insert comprises a rigid mesh configured to prevent animals and certain insects from accessing the interior of the enclosure.

16. The device of claim 14, wherein:
said insert comprises a transparent or translucent material having greenhouse properties.

17. The device of claim 11, wherein:
a portion of said panels comprise a horizontally extending shelf configured to receive one or more of said panels in a horizontal position such that said received panels form a roof for said enclosure.

18. The device of claim 11, further comprising:
a roof panel hingedly attached to one or more side panels, wherein said roof panel is configured to be manually swung upward so as to allow access to the interior of said device.

19. The device of claim 11, further comprising:
a first portion of said panels comprises an inwardly curved latch; and
a second portion of said panels comprises an outwardly curved latch;
wherein said inwardly curved latches and said outwardly curved latches are configured to be selectively secured to one another.

20. An apparatus for protecting a plot of land_{.}, comprising:
a base unit comprising:
a perimeter wall defining a bottom opening,
a substantially rigid bottom panel extending across said bottom opening and having a plurality of of openings located therein, said openings sized to allow air and water to pass through but small enough to prevent ground rodents from being able to pass through;
a plurality of structural grid members
removably securable to said perimeter wall;
a wire or plastic mesh extending about said grid members, said grid members and said mesh configured to prevent animals from accessing the interior of the apparatus, while allowing rain and sunshine into the apparatus.
